(19) United States
(12) Patent Application Publication
(10) Pub. No.: US 2007/0040499 A1
(43) Pub. Date: Feb. 22, 2007

(54) Light emitting device, display device and method of fabricating the same

(75) Inventor: Yukitami Mizuno, Otaku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-Ku (JP)

(21) Appl. No.: 11/503,961

(22) Filed: Aug. 15, 2006

(30) Foreign Application Priority Data
Aug. 16, 2005 (JP) 2005-235925

(51) Int. Cl. H01J 1/62

(52) U.S. Cl. 313/509

(57) ABSTRACT

In a light emitting device, a first distance between the first substrate and the second substrate in an area where a luminescent material and a sealant are separate from each other is larger than a second distance between the first substrate and the second substrate in a clearance where the luminescent material is filled, and a third distance in the area between the luminescent material and the sealant is larger than the second distance.

### CROSS REFERENCE TO RELATED APPLICATION

This application is based upon and claims the benefit of priority from prior Japanese Patent Application No. 2005-235925 filed on Aug. 16, 2005, the entire contents of which are incorporated by reference herein.

### BACKGROUND OF THE INVENTION

1. Field of the Invention

This invention relates to a light emitting device and a display device which are made of luminescent and display materials in the form of liquid or gel, and a method of fabricating the light emitting device and display device.

2. Description of the Related Art

Light emitting devices made of electrochemical luminescent (ECL) materials are widely applied to light fixtures, signaling units, TV apparatuses, display devices and back lights of cellular phones, and so on.

In the light emitting device, liquid or gel luminescent materials are supported at a clearance of a pair of transparent substrates or the like which include electrodes. The light emitting device emits light when a voltage is applied to the electrodes.

At the same time, display devices are made of liquid crystals, electrophoretic materials, and electro-chemical materials which are not luminescent in themselves but become luminescent in response to outside light.

With the foregoing light emitting device or the display device, the liquid or gel luminescent materials tend to evaporate with a lapse of time, so that the light emitting device or the display device tends to suffer from varying light emitting and display properties in response to changes of such materials. Further, oxygen or moisture in the atmosphere adversely affects the luminescent materials and display materials, which worsens light emitting properties or display properties.

In order to overcome the foregoing problems, JP-A 2002-287172 (KOKAI) proposes a method to cover peripheries of the substrates using a sealant and to isolate the display materials supported by the substrates. This method is effective in preventing the display materials and the luminescent materials from being exposed to the atmosphere, and in suppressing variations of the properties of the display materials and the luminescent materials.

However, the luminescent materials may suffer from its luminescent properties changed by the sealant. For instance, when a luminescent material such as ECL or the like is contained in an organic solvent, the sealant may be dissolved by the organic solvent, get mixed into the luminescent material, and change the light emitting properties of the luminescent material.

### BRIEF SUMMARY OF THE INVENTION

According to a first aspect of the embodiment, there is provided a light emitting device which includes: a first substrate; a second substrate facing with the first substrate; a liquid or gelled luminescent material filled in a clearance between the first substrate and the second substrate; a first electrode placed on the first substrate and being in contact with the luminescent material; a second electrode placed on the second substrate and being in contact with the luminescent material; and a sealant placed between the first substrate and the second substrate, being separate from the luminescent material, and isolating the luminescent material from an environment. With the light emitting device, a first distance between the first substrate and the second substrate in an area where the luminescent material and the sealant are separate from each other is larger than a second distance between the first substrate and the second substrate in the clearance where the luminescent material is filled; and a third distance in the area between the luminescent material and the sealant is larger than the second distance.

In accordance with a second aspect of the embodiment, there is provided a display device which includes: a first substrate; a second substrate facing with the first substrate; a liquid or gelled display material filled in a clearance between the first substrate and the second substrate; a first electrode placed on the first substrate and being in contact with the display material; a second electrode placed on the second substrate and being in contact with the display material; and a sealant placed between the first substrate and the second substrate, being separate from the display material, and isolating the display material from an environment. With the display device, a first distance between the first substrate and the second substrate in an area where the display material and the sealant are separate from each other is larger than a second distance between the first substrate and the second substrate in the clearance where the display material is filled; and a third distance in the area between the display material and the sealant is larger than the second distance.

According to a third aspect of the embodiment, there is provided a light emitting device which includes: a first substrate; a second substrate facing with the first substrate; a liquid or gelled luminescent material filled in a clearance between the first substrate and the second substrate; a first electrode placed on the first substrate and being in contact with the luminescent material; a second electrode placed on the second substrate and being in contact with the luminescent material; and a sealant placed between the first substrate and the second substrate, being separate from the luminescent material, and isolating the luminescent material from an environment. In the light emitting device, an affinity between the luminescent material and the first and second substrates in a first area where the luminescent material and the sealant are separate from each other is lower than an affinity between the first substrate and the second substrate in a second area where the luminescent material is filled.

According to a fourth aspect of the embodiment, there is provided a display device which includes: a first substrate; a second substrate facing with the first substrate; a liquid or gelled display material filled in a clearance between the first substrate and the second substrate; a first electrode placed on the first substrate and being in contact with the display material; a second electrode placed on the second substrate and being in contact with the display material; and a sealant placed between the first substrate and the second substrate, being separate from the display material, and isolating the display material from an environment. With the light emitting device, an affinity between the display material and the first and second substrates in a first area where the display material and the sealant are separately placed is lower than an affinity between the first substrate and the second substrate in a second area where the display material is provided.

In accordance with a fifth aspect of the embodiment, there is provided a method of fabricating a light emitting device. The method includes: polishing a periphery of an electrode forming region where an electrode of a first substrate is formed, and raising the electrode forming region; polishing a periphery of an electrode forming region where an electrode of a second substrate is formed, and raising the electrode forming region; spraying a spacer onto the first electrode forming region or the second electrode forming region; placing the first and second substrates in such a manner that the first electrode forming region and the second electrode forming region face with each other via the spacer; partly sealing a peripheral area of a clearance between the first and second substrates; filling a luminescent material into the clearance between the first and second substrates via a non-sealed peripheral area; and closing the non-sealed peripheral area of the clearance between the first and second substrates.

In a final aspect of the embodiment, there is provided a method of fabricating a display device. The method includes: polishing a periphery of an electrode forming region where an electrode of a first substrate is formed, and raising the electrode forming region; polishing a periphery of an electrode forming region where an electrode of a second substrate is formed, and raising the electrode forming region; spraying a spacer onto the first electrode forming region or the second electrode forming region; placing the first and second substrates in such a manner that the first electrode forming region and the second electrode forming region face with each other via the spacer; partly sealing a peripheral area of a clearance between the first and second substrates; filling a display material into the clearance between the first and second substrates via a non-sealed peripheral area; and closing the non-sealed peripheral area between the first and second substrates.

### BRIEF DESCRIPTION OF THE DRAWINGS

FIG. 1 is a perspective view of a light emitting device according to a first embodiment of the invention;

FIG. 2 is a longitudinal section of the light emitting device of FIG. 1;

FIG. 3 is a perspective view of one of substrates of the light emitting device;

FIG. 4 is a further longitudinal section of the light emitting device of FIG. 1;

FIG. 5 is a cross section of the light emitting device of FIG. 1;

FIG. 6A, FIG. 6B and FIG. 6C are longitudinal sections of the light emitting device, showing how a luminescent material is reliably retained;

FIG. 7A, FIG. 7B and FIG. 7C are cross sections of the light emitting device of FIG. 1, showing how the luminescent material is reliably retained;

FIG. 8A and FIG. 8B show a waveform of a voltage applied to the light emitting device and a light intensity of the light emitting device;

FIG. 9 is a longitudinal section of a light emitting device in a second embodiment of the invention;

FIG. 10 is a perspective view of the light emitting device in a further embodiment of the invention;

FIG. 11 is a longitudinal section of the light emitting device of FIG. 10; and

FIG. 12 is a perspective view of the light emitting device of FIG. 10.

### DETAILED DESCRIPTION OF THE INVENTION

Following is a detailed description of the invention as illustrated by the attached drawings, in which like numbers refer to like part throughout. The drawings are schematic, and are depicted using scales which sometimes differ from those of actual products, and which are different in some drawings.

### First Embodiment

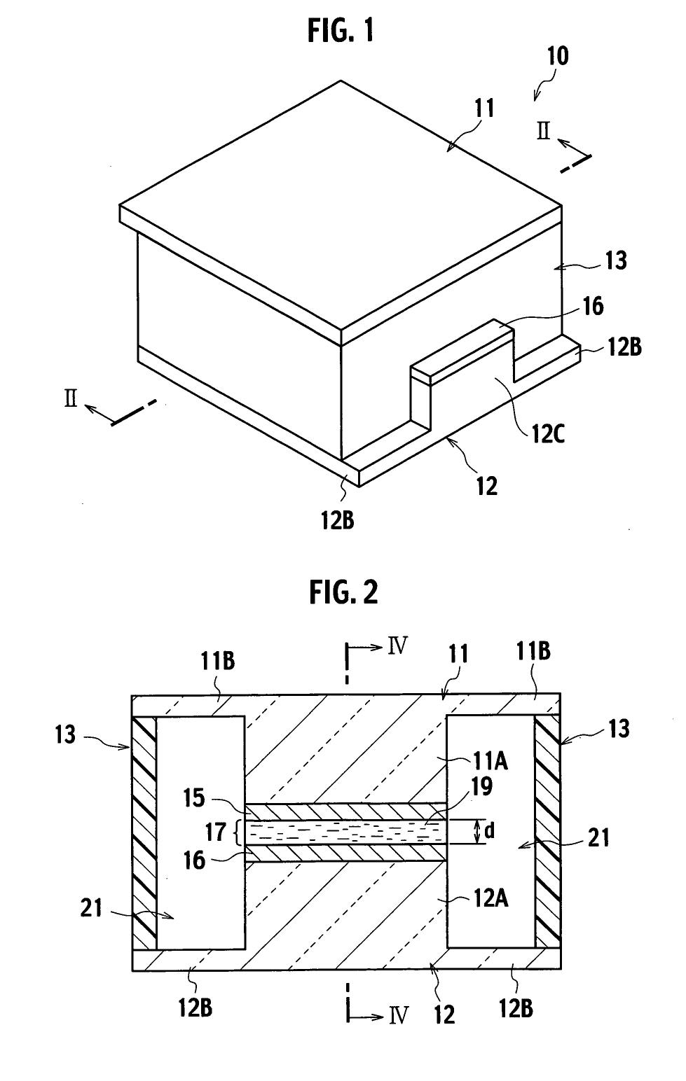

Referring to FIG. 1, a light emitting device 10 includes first and second transparent substrates 11 and 12 which are made of glass and face with each other, and a sealant 13 covering peripheries of the first and second substrates 11 and 12.

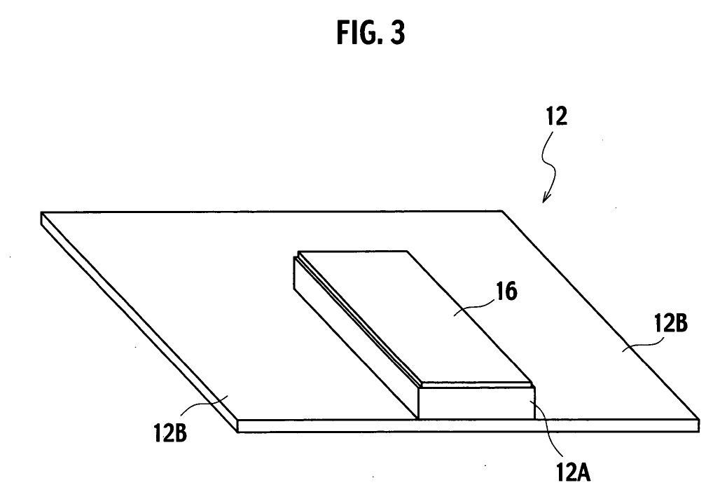

FIG. 2 is a longitudinal section of the light emitting device, taken along line II-II in FIG. 1, and FIG. 3 is a perspective view of one of substrates of the light emitting device. As shown in these drawings, the first and second substrates 11 and 12 are similarly structured. The second substrate 12 includes an electrode support 12A having an electrode 16 at one end thereof, and a flange 12B at a base thereof. The electrode 16 is made by patterning a transparent ITO (oxide indium tin) film on the second substrate 12.

The second substrate 12 is polished to make a step between the electrode support 12A and the flange 12B.

The first substrate 11 includes an electrode support 11A having a electrode 15 at one end thereof, and a flange 11B at a base thereof The electrode 15 is made by patterning a transparent ITO film on the second substrate 12. The first substrate 11 is polished to make a step between the electrode support 11A and the flange 11B.

The first and second glass substrates 11 and 12 are utilized in the first example. Alternatively, the first and second substrates 11 and 12 may be plastic substrates such as PET (polyethylene terephthalate), PEN (polyethylene naphthalene), PES (polyether sulfone), PC (polycarbonate) and so on. When serving as a first observation surface, the first substrate 11 is preferably made of a material which absorbs little visible light. On the contrary, the second substrate 12 serving as a second observation surface is preferably made of a material which absorbs little visible light.

The first and second substrates 11 and 12 are placed such that the electrodes 15 and 16 face with each other via a clearance 17, which is 4 μm size and in the shape of a cuboid in the first example. The clearance 17 is preferably filled by a plastic spacer such as polyethylene and so on, or glass.

When the first substrate 11 is used as the observation surface, the electrode 15 thereon is a transparent electrode, which is made of oxides of transition metals such as titanium, zirconium, hafnium, strontium, zinc, tin, indium, yttrium, lanthanum, vanadium, niobium, tantalum, chrome and molybdenum; oxides of tungsten; perovskite such as Sr TiO₃, CaTiO₃, BaTiO₃, MgTiO₃ and SrNb₂O₆; or composite oxides, and oxide compounds of the foregoing materials, GaN, and so on. The electrode 16 of the second substrate 12 functions as a reflecting electrode when the first substrate 11 serves as the observation surface. The reflecting electrode is preferably made of aluminum, silver or the like. The electrodes 15 and 16 are preferably large in order to increase an aperture ratio, have the same size, and are made of the same material.

The material filling the clearance 17 between the electrodes 15 and 16 is a liquid or gelled luminescent material 19 having ECL (electrochemical luminescence) properties. Material with the ECL properties are polycyclic aromatic compounds such as a naphthacene derivative (rubrene, 5,12-diphenyl napthtancene), an anthracene derivative (9,10-diphenyl anthracene), a pentacene derivative (6,10-diphenyl pentacene) and a derivative (dibenzo tetra (methyl phenyl); _{II} conjugate high polymers such as poly-para-phenylene vinylene derivatie, a polythiophenine derivative, a poly-para-phenylene derivative, and polyfluorene derivates; hetero aromatic compounds such as coumarin,; chelete metal complexes such as Ru(bpy)₃₂⁻; and organic metallic compounds such as tris (2-phenyl pyridine) iridium and chelete lanthanoid complex.

In order to promote the oxidation—reduction reaction, the luminescent material 19 preferably contains supporting salt. In order to dissolve the supporting salt into ions, the luminescent material 19 also contains a solvent (for a liquid electrolyte) or a gelled high polymer (for a solid electrolyte) which is expanded in the solvent. The support salt is preferably tetra butyl ammonium perchlorate; hexafluorophosphate kalium; tri-fluoro methanesulfonate lithim; lithium perchlorate; tetra fluoboric acid tetra-n-buthyl ammonium; tri-propylamine; fluoboric amid tetra-n-buthyl ammonium; and so on. The solvent is preferably acetonitrile; N, N-dimethylformamide; propylene carbonate; o-dichlorobenzene; glycerin; water; ethyl alcohol; propyl alcohol; dimethyl carbonate; ethylene carbonate; γ-buthyrolactone; NMP; 2-methyltetra hydrofuran; toluene; tetra hydrofuran; benzonitrile; cyclohexane; n-hexane; acetone; nitrobenzene; 1,3-dioxolan; furan; benzotrifluoride; and so on. The gelled high polymer is preferably copolymers such as polyacrylonitrile (PAN); vinylidene fluoride (VDF); propylene hexafluoride (HFP); and polyethylene oxido (PEO).

The luminescent material 19 is dissolved in the solvent with the supporting salt, and is poured into the clearance 17 between the electrodes 15 and 16.

The sealant 13 is provided around the peripheries of the first and second substrates 11 and 12 where the flanges 11B and 12B are present. The sealant 13 is preferably an adhesive which is cured by a physical stimulant such as light and heat, or an adhesive which is cured with time. The adhesive may be preferably made of an epoxy resin, but may be made of any appropriate material.

A clearance 21 is defined by the sealant 13, and sides of the electrode supports 11A and 11B and, flanges 11B and 12B of the first and second substrates 11 and 12. An argon gas or a nitrogen gas is available as an insert gas. The argon gas is preferably filled in the clearance 21.

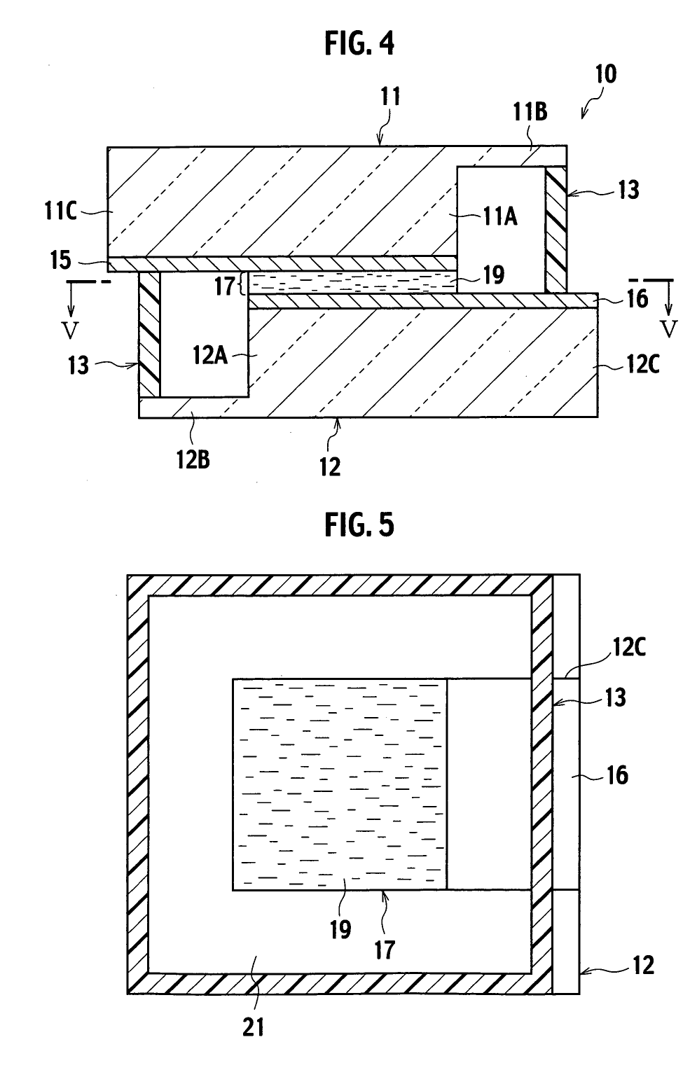

Referring to FIG. 4 which is a longitudinal section of the light emitting device, taken along line IV-IV in FIG. 2, the electrode supports 11A and 11B of the first and second substrates 11 and 12 have extensions 11C and 12C sticking out in opposite directions. The electrodes 15 and 16 placed on the extensions 11C and 12C are exposed out of the light emitting device 10 compared with the sealant 13.

When a voltage is applied to the electrodes 15 and 16, the electrochemical oxidation-reduction reaction is caused in the ECL material, which energizes the ECL material. When the ECL material is de-energized, light is emitted. In other words, in response to the voltage application to the electrodes 15 and 16, the ECL material is oxidized near the electrodes 15 and 16 and becomes oxidizing species (i.e., a cation radical), and is then reduced and becomes reduction species (i.e., an anion radical). When the cation radical and the anion radical encounter, the ECL material is energized. Light is emitted when the ECL material is de-energized.

The space 21 enclosed by the sealant 13 and the first and second substrates 11 and 12 communicates with the clearance 17 between the electrodes 15 and 16. The clearance 21 has a size which is larger than “d” between the electrodes 15 and 16 (refer to FIG. 2). Therefore, the luminescent material 19 in the clearance 17 does not move to the clearance 21 because of the capillary phenomenon, and is prevented from being brought into contact with the sealant 13.

Referring to FIG. 5 which is a cross section taken along line V-V in FIG. 4, the luminescent material 19 in the clearance 17 which is in the cuboid-shaped emits light in response to the voltage application to the first and second electrodes 15 and 16.

The luminescent material 19 in the clearance 17 does not move to the clearance 21 under the following conditions.

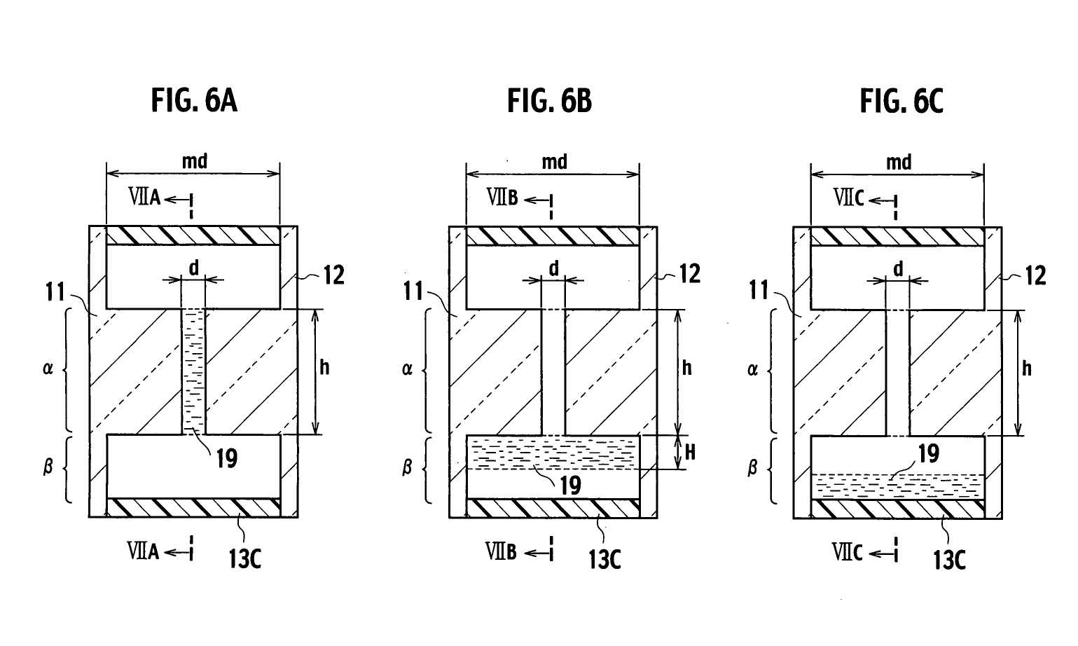

The clearance 17 filled with the luminescent material 19 is in the shape of the cuboid as shown in FIG. 5. Referring to FIG. 6A, FIG. 6B and FIG. 6C, the luminescent material 19 is assumed to move between a small area α and an area β which is larger than the area α. The areas α and β are vertically positioned, and communicate each other.

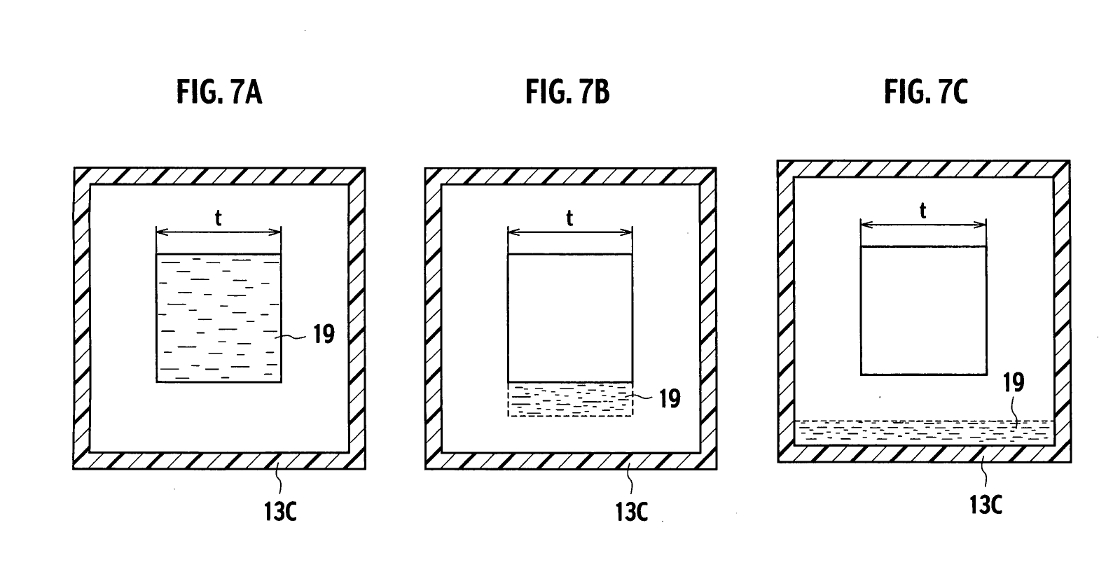

FIG. 7A is a cross section of the light emitting device, taken along line VIIA-VIIA in FIG. 6A. FIG. 7B is a cross section of the light emitting device, taken along line VIIB-VIIB in FIG. 6B. FIG. 7C is a cross section of the light emitting device, taken along line VIIC-VIIC in FIG. 6C.

FIG. 6A and FIG. 7A show that the luminescent material 19 stays in the area α (in the state A). FIG. 6B and FIG. 7B show that all of the luminescent material 19 stays in the upper part of the area β (in the state B). Further, FIG. 6C and FIG. 7C show that the luminescent material 19 moves to and stays at the bottom of the area β. In other words, the state B (shown in FIG. 6B and FIG. 7B) is a transient state in which the luminescent material 19 is moving from the area α to the area β. In this embodiment, the condition for preventing the luminescent material 19 from being in the state B while moving between the area α and the area β is established paying attention to changes of energy in the states A and B of the luminescent material 19.

Potential energy of the liquid (i.e., the luminescent material 19) will be described first of all. As shown in FIG. 6A to FIG. 6C and FIGS. 7A to FIG. 7C, volume V_{α} of the clearance 17 in the area α is equal to d·t·h, where the character h denotes a height of the area α (i.e., a length of a first side of the rectangular clearance 17 along the first substrate 11 or second 12 shown in FIG. 6A to FIG. 6C); the character d denotes a distance between the first and second substrates 11 and 12 in the clearance 17; and the character t denotes a width of the clearance 17 (i.e., a length of a second side connecting to the first side of the clearance 17). Further, volume V_{B} of the luminescent material 19 in the state B (i.e., all of the liquid has moved to the area β from the area α) is expressed as follows.
V_{B}=t×H×md=d×t×h (1)
where the character t and the character md denote the width of the clearance 17; and the character H denotes a height of the liquid which has moved to an upper part of the area β. The height H is expressed as follows.
H=d×t×h/(t×md)=h/m (2)

The potential energy G of the liquid in the area α (in the state A) is expressed by the following formula;
G=d×t×h×ρ×(1+1/m)×(h/2) (3)
where the character ρ denotes a density of the liquid; the character g denotes a gravity acceleration; and (½)·h+(½)·H=(1+1/m)×(h/2) denotes a position of the liquid in the area α (center of the area α). Further, the position of the liquid at the area β is assumed to be a point of origin.

The following describe a variation of a surface area of the liquid which changes the state B to the state A. An area S_{GL} of the liquid in the state B and at the interface of air (gas) is md·t+2·md·H+d·t=dmt+2dh+dt. Further, the area S_{GL} of the liquid in the state A at the interface of air (gas) is 2dh+2dt. Therefore, the variation ΔS_{GL} of the interfacial area of the liquid which changes its state from B to A can be expressed as follows.
ΔS_{GL}=2dh+2dt−dmt−2dh−dt=dt(1−m) (4)

A contact area of the liquid in the state A with the first and second substrates 11 and 12 is 2ht while a contact area of the liquid in the state B with the first and second substrates 11 and 12 is 2·t·H+(md−d)·t. The following formula is established where the character S_{LS} denotes an interfacial area between the liquid and the substrates 11 and 12, and the character ΔS_{LS} denotes a variation n interfacial area of the liquid which changes its state from B to A.

$$\begin{matrix}Δ {S}_{LS} = 2 ht - 2 \cdot t \cdot H - ( md - d ) \cdot t \\ = 2 ht - 2 \cdot t \cdot ( h / m ) - ( m - 1 ) dt \\ = ( 1 - 1 / m ) 2 ht - ( m - 1 ) dt \\ = - Δ {S}_{SG}\end{matrix} \qquad ( 5 )$$

In the formula (5), ΔS_{LS} is equal to an absolute value of a variation ΔS_{SG} of the interfacial area between the first and second substrates 11 and 12 and a gas filled between them.

Work W for increasing a surface area by ΔSᵢ is expressed by a formula (6) when surface tension γᵢ is applied.
W=γᵢ·ΔSᵢ (6)
The work W (an energy variation in response to the variation of the surface area of the liquid from the state B to the state A) can be rewritten as follows.
W=γ_{GL}·ΔS_{GL}+(γ_{LS}−γ_{SG}) ΔS_{LS} (7)
In formula (7), the character γ_{GL} denotes a surface tension acting on the liquid and the gas filled in the liquid; the character γ_{LS} denotes a surface tension acting on the liquid and the first and second substrates 11 and 12; and the character γ_{SG} denotes a surface tension acting on the first and substrates 11 and 12 and the gas filled therein.

A total energy variation U should be negative in order that the state A remains stable in view of energy, and is expressed as follows.
U=G+W<0 (8)
Formula (9) will be derived by substituting the potential energy G and the energy variation W with the formulas (4), (5) and (7).

$$\begin{matrix}U = G + {γ}_{GL} \cdot Δ {S}_{GL} + ( {γ}_{LS} - {γ}_{SG} ) Δ {S}_{LS} \\ = G + {γ}_{GL} \cdot \{ dt ( 1 - m ) \} + ( {γ}_{LS} - {γ}_{SG} ) \cdot \\ \{ ( 1 - 1 / m ) 2 ht - ( m - 1 ) dt \} \\ < 0\end{matrix} \qquad ( 9 )$$

Further, formula 10 will be derived by substituting the formula (9) with the formula (3).
d×t×h×p×(1+1/m)×(h/2)+γ_{GL}·{dt(1−m)}+(γ_{LS}−γ_{SG})·{(1−1/m) 2ht−(m−1) dt}<0 (10)

The light emitting device 10 is structured such that the first and second substrates 11 and 12 are spaced from each other by the distance d in the clearance 17 (i.e., in the area α), and the first and second substrates 11 and 12 are spaced from each other by the distance m×d in the area β where the luminescent material 19 is separate from the sealant 13. In this case, m is set in order to satisfy the formula (10). Therefore, the luminescent material 19 does not change its state A to the state B, so that the luminescent material (ECL) 19 (shown in FIG. 2 to FIG. 4) can be stably maintained between the electrodes 15 and 16.

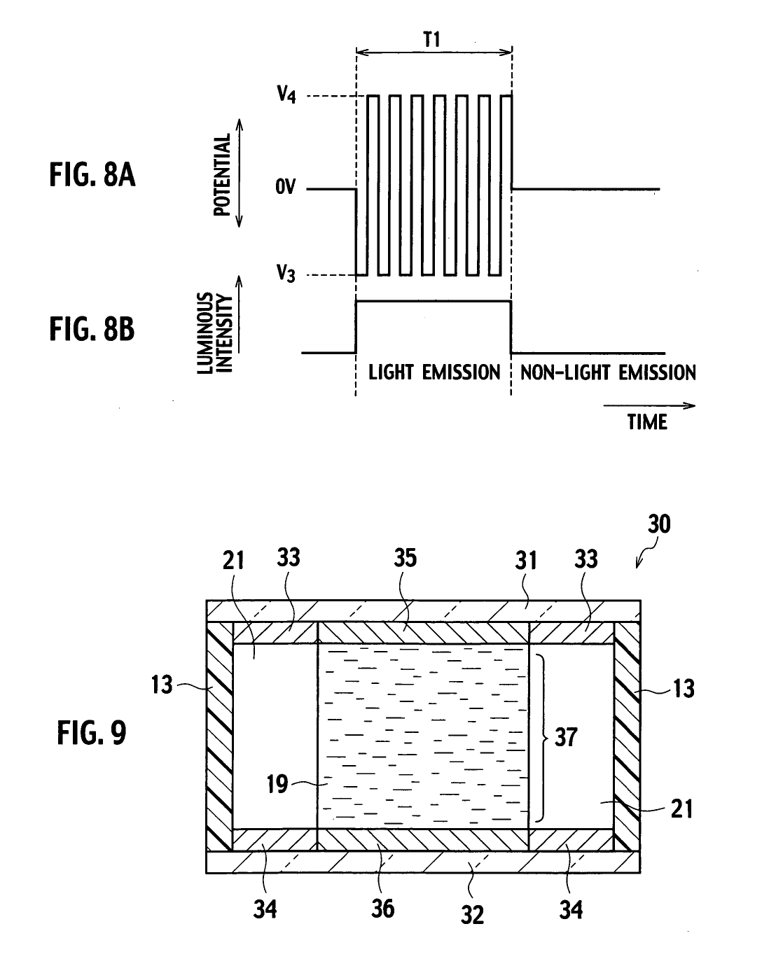

The light emitting device 10 operates and functions as described hereinafter. A DC or AC voltage is applied between the first and second electrodes 15 and 16 of the light emitting device 10. In this embodiment, the AC voltage as shown in FIG. 8A is applied. When the AC voltage is applied for a time period of T1, a potential of the first electrode 15 alternately changes between V₃ and V₄. The potential V₃ is a negative reduction potential where the luminescent (ECL) material 19 becomes an anion radical while the potential V₄ is a positive oxidizing potential where the luminescent (ECL) material 19 becomes a cation radical. In this state, the potential of the second electrode 16 has a polarity reverse to that of the first electrode 15 during the period (light emitting period) T1.

The voltages having the opposite polarities are applied to the electrodes 15 and 16 during the period T1, so that the anion radicals and cation radicals are alternately generated in the luminescent material 19. When the anion and cation radicals come across, the luminescent material 19 is energized, and emits light while its deactivation process. Usually, the voltages applied to the electrodes 15 and 16 have frequencies of several ten Hz. The present invention is not always limited to such frequencies.

The light emitting device 10 emits light while the AC voltage is applied to the electrodes 11 and 12 for the period T1.

With the first substrate 11, the electrode support 11A stands out from the flange 11B (i.e., there is a step between them). The same holds true to the second substrate 12. Therefore, the space 21 is formed with the substrates 11 and 12 facing with each other.

The distance between the flanges 11B and 12B in the clearance 21 is larger than the distance between the electrode supports 11A and 12A in the clearance 17 where the luminescent material 19 is filled. Therefore, the luminescent material 19 in the clearance 17 is prevented from being moved to the clearance 21 because of the capillary phenomenon.

The luminescent material 19 stably remains in the clearance 17 as long as the light emitting device 10 is structured to satisfy the formula (10), and when the requirement in which a total energy variation U (=G+W) for enabling the luminescent material 19 to move from the clearance 21 (in the state B) to the clearance 17 (in the state A) is negative should be satisfied. The luminescent material 19 is prevented from moving to the clearance 21, and from being brought into contact with the sealant 13.

Further, the sealant 13 is prevented from being dissolved by the organic solvent contained in the luminescent material 19. The sealant 13 reliably isolates the luminescent material 19 from the atmosphere, which is effective in lengthening the life of the luminescent material 19 as a light emitting element.

Still further, deterioration of a cross-linking reaction due to infiltration of the solvent into the sealant 13 is suppressed, which prevents the sealant 13 from being hard to cured.

Further, the sealant 13 is prevented from being dissolved by the organic medium in the luminescent material 19 and from varying light emitting properties of the luminescent material 19. This is effective in lengthening the life of the luminescent material 19.

The luminescent material 19 is separate from the sealant 13, and is prevented from being mixed with the sealant 13 which is soft. This prevents worsening of the light emitting properties of the luminescent material 19.

The luminescent material 19 and the sealant 13 are separate from each other, so that heat generated in the manufacturing process of the light emitting device 10 during curing of the sealant 13 is prevented from being transmitted to the luminescent material 19. This is effective in preventing light emitting properties of the luminescent material 19 from being worsened.

If the sealant 13 is cured in response to light, it is possible to prevent the luminescent material 19 from being applied such light. This is effective in preventing worsening of the light emitting properties of the luminescent material 19 in response to light.

The luminescent material 19 is housed only in the clearance 17 between the electrode supports 11A and 12A, and is out of contact with wirings for the electrodes 15 and 16 on the first and second substrates 11 and 12, which is effective in preventing unnecessary light from being emitted outside where the electrodes 15 and 16 are formed.

### EXAMPLE 1

The light emitting device 10 is structured and fabricated as follows. It is assumed here that the light emitting device 10 includes one pixel which is in the shape of a 4-mm square and is a monochromatic electrochemical reaction element.

First of all, 1.1-mm thick glass substrates are prepared as the first and second substrates 11 and 12. ITO (indium oxide tin) transparent conductive films are sputtered onto the first and second substrates 11 and 12, and are patterned to make the electrodes 15 and 16 on the first and second substrates 11 and 12.

The first and second substrates 11 and 12 are polished at non-patterned positions using an ultrasonic finishing machine. The first and second substrates 11 and 12 are 0.5 mm thick at the polished positions, which serve as the flanges 11B and 12B. There is a height difference between the electrode supports 11A and 12A and the flanges 11B and 12B.

A 4-μL m thick spacer is sprayed onto the electrode support 1A. The sealant 13 (a thermosetting adhesive) is applied onto two sides of the flange 12B of the second substrate 12. The first and second substrates 11 and 12 are placed to face with each other, and are glued together. In this state, the 4-μL m thick clearance is made between the electrode supports 11A and 12A. The flanges 11B and 12B stand off by 1.2 mm. The first and second substrates 11 and 12 are heated in an oven in order to cure the sealant 13.

Since the sealant 13 is applied at the two sides of the first and second substrates 11 and 12, the clearance 17 where the first and second electrodes 15 and 16 are present opens to an outside via the remaining two sides of the first and second substrates 11 and 12. The luminescent material 19 is filled in the clearance 17 via an opening using a syringe. The luminescent material 19 is preferably made of a solution in which acetonitrile and o-dichlolobenzene are mixed in the ratio of 1 to 2, and a solution in which rubrene is dissolved in a concentration of 0.1 mol/L. A necessary amount of the luminescent material 19 is poured into the clearance 17 using the syringe in an argon gas as an inert gas.

After the luminescent material 19 is filled in the clearance 17, the light curing resin (sealant) is applied to the two sides where the first and second substrates 11 and 12 are open, and is cured by light. Therefore, the peripheries of the first and second substrates 11 and 12 are sealed. The thermosetting resin sealant which is applied prior to filling the luminescent material 19 is heated in the oven. On the contrary, the light curing resin sealant applied after filling the luminescent material is effective in protecting the luminescent material 19 against heat. This prevents the luminescent material 19 from being aged by heat.

The open area of the first and second substrates 11 and 12 are preferably as wide as possible in order to insert the syringe needle. Therefore, the sealant 13 is applied to the side where the electrode supports 1A and 12A extend. Then, the syringe needle is inserted into the clearance 17 via the side where the electrode supports 11A and 12A do not extend, which enables the luminescent material 19 to be easily filled into the clearance 17.

The luminescent material 19 is out of contact with the sealant 13 in the light emitting device 10, which assures high light emitting efficiency compared with light emitting devices in which luminescent material and sealants are in contact with each another. The light emitting device 10 of the embodiment can assure longer life.

### Second Embodiment

Referring to FIG. 9, a light emitting device 30 in a second embodiment includes flat substrates 31 and 32 which face with each other. An electrode 35 made of a transparent and conductive ITO film is patterned on a part of the substrate 31. Further, an electrode 36 made of a transparent and conductive ITO film is patterned on a part of the substrate 32 facing with the electrode 35 on the substrate 31.

A luminescent material 19 is filled in a space 37 between the substrates 31 and 32 where the electrodes 35 and 36 are placed. When a DC or AC voltage is applied to the electrodes 35 and 36, light emission is conducted.

Layers 33 and 34 whose surfaces are specially treated to have a low affinity to the luminescent material 19 are placed on the substrates 31 and 32 where the electrodes 35 and 36 are not present. The affinity of the layers 33 and 34 to the luminescent material 19 is designed to be lower than the affinity of the area, where the electrodes 35 and 36 are present, to the luminescent material 19. For instance, the area where the electrodes 35 and 36 are present is masked first of all. The position where the substrates 31 and 32 face with each other without masked area is subject to the trimethylacetic treatment using trimethylsilyl chloride, and is made hydrophobic. The luminescent material 19 (ECL material) is preferably an acetonitrile solution in which Ru(bpy)₃₂⁻ ruthenium complex is dissolved. The liquid or gelled substance containing the luminescent material 19 is repelled from the surfaces of the substrates 31 and 32 at the position where the electrodes 35 and 36 are not present, so that the luminescent material 19 is reliably maintained in the clearance 17 between the electrodes 35 and 36. Therefore, the luminescent material 19 is prevented from being in contact with the sealant 13 which is applied around the luminescent material 19 via the clearance 21.

The surfaces of the substrates 31 and 32 are also made hydrophobic using the fluoride plasma treatment and so on.

Alternatively, the layers 33 and 34 having a low affinity to the luminescent material 19 may be hydrophilic while the substrates 31 and 32 where the electrodes 35 and 36 are present may be hydrophobic. Further, it is preferable that the layers 33 and 34 may be hydrophobic on their sufaces, and the substrates 31 and 32 carrying the electrodes 35 and 36 may be hydrophilic. The surfaces of the substrates 31 and 32 may be ozone-treated in order to make them hydrophilic. The surfaces of the substrates 31 and 32 where the electrodes 35 and 36 are present have improved the affinity to the luminescent material 19 while the layers 33 and 34 reduce their affinity to the luminescent material 19. when the areas where the electrodes 35 and 36 are provided on the substrates 31 and 32 are hydrophilic while the layers 33 and 34 are hydrophobic, the luminescent material 19 may be an ECL material called rubrene, which is dissolved in a DMF (N,N-dimethylformamide medium. The medium is known to be hydrophilic. On the other hand, when the areas where the electrodes 35 and 36 are provided on the substrates 31 and 32 are hydrophobic while the layers 33 and 34 are hydrophilic, the luminescent material 19 (ECL material) may be polyfluorene, which is dissolved in an o-dichlorobebzene medium, and is known to be hydrophobic. In the foregoing light emitting device 30, the luminescent material 19 is maintained out of contact with the sealant 13, and is protected against being aged by the sealant, and against worsening the light emitting properties. Still further, in the foregoing light emitting device 30, the luminescent material 19 is protected against worsening the light emitting properties by heat or light when the sealant is cured, and against emitting unnecessary light due to the wirings for the electrodes 35 and 36.

### Other Embodiments

In the first embodiment of the invention, the clearance between the electrodes 15 and 16 is sized in accordance with the spacer sprayed between them. Alternatively, the spacer may be contained in the sealant 13 and form the clearance of a desired size between the electrodes 15 and 16.

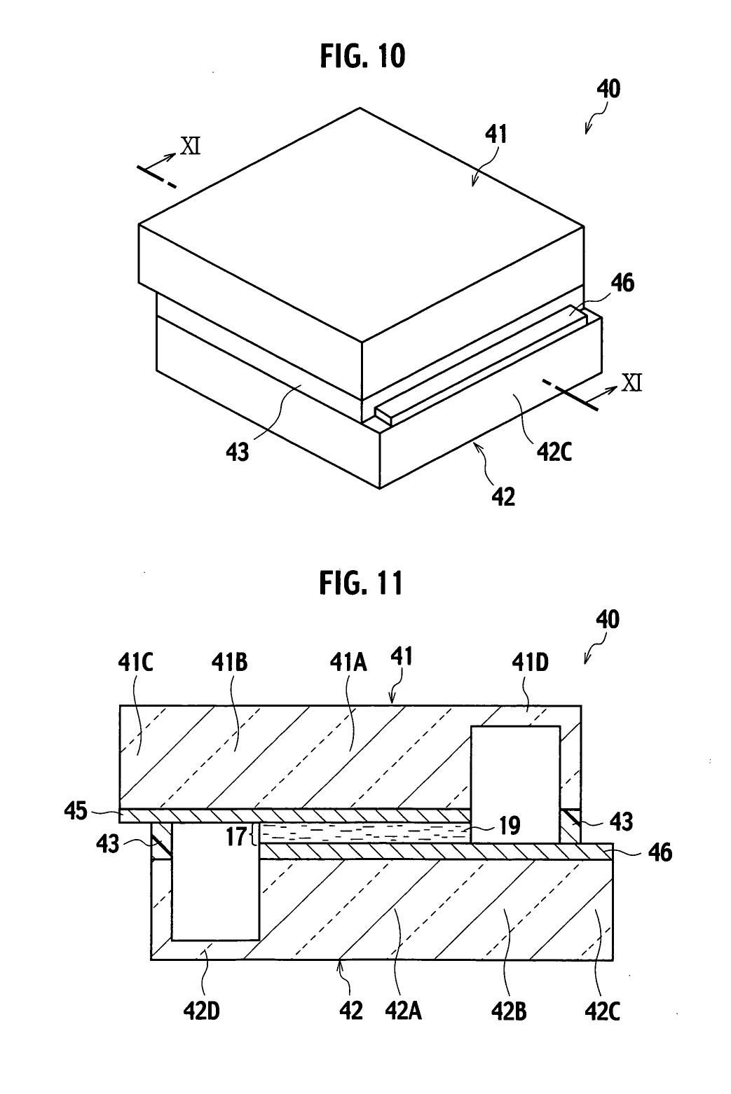

Referring to FIG. 10, a light emitting device 40 includes substrates 41 and 42 which are made of glass substrates and face with each other, and a sealant 43 covering the peripheries of the substrates 41 and 42. The sealant 43 contains a spacer.

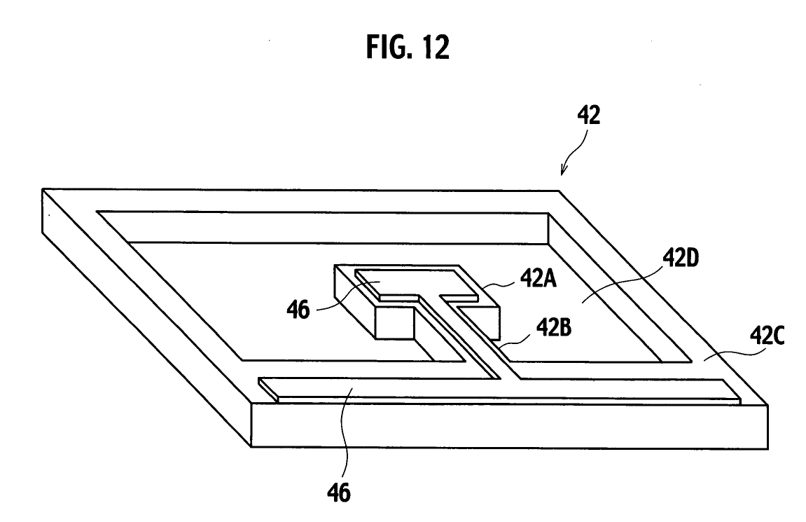

FIG. 11 is a cross section of the light emitting device 40, taken along line XI-XI in FIG. 10, and FIG. 12 is a perspective view of the substrate 42 of the light emitting device 40. The substrate 41 is structured identically to the substrate 42. The substrate 42 includes a transparent electrode 46, an electrode support 42A, a sealing seat 42C, and a joint 42B. The transparent electrode 46 is made of an ITO film, and is patterned on the electrode support 42A which is raised at the center of the substrate 42. The sealing seat 42C extends around the bottom 42D of the substrate 42. The joint 42B stands out from the bottom 42D of the substrate 42, and joins the electrode support 42A and the sealing seat 42C. The electrode 46 extends from one end of the electrode support 42A to ends of the sealing seat 42C and the joint 42, and is exposed at a part of the sealing seat 42C (refer to FIG. 10).

The substrate 41 includes a transparent electrode 45, an electrode support 41A, a sealing seat 41C, and a joint 41B. The transparent electrode 45 is made of an ITO film, and is patterned on the electrode support 41A which stands out at the center of the substrate 41. The sealing seat 41C extends around the bottom 41D of the substrate 41. The joint 41B stands out from the bottom 41D of the substrate 41, and joins the electrode support 41A and the sealing seat 41C. The electrode 45 extends from one end of the electrode support 41A to ends of the sealing seat 41C and the joint 41, and is exposed at a part of the sealing seat 41C.

The sealing seats 41C and 42C are effective in thinning the sealant 43. The sealant 43 includes a spacer which determines a clearance between the electrodes 45 and 46. The spacer is minute and is approximately several μm thick because of the thin sealant. Therefore, the space between the electrodes 45 and 46 can be made remarkably precise compared with when the spacer has a large thickness of several hundred μm.

In the first and second embodiments, the inert gas is filled in the clearance 21. Alternatively, an absorbent may be provided in the clearance 21, and is preferably silica gel, magnesium sulfate, molecular sieve, calcium carbonate or the like. Further, the absorbent is preferably spherical, has a diameter which is larger than a distance between the substrates in the clearance 17, and is smaller than a distance between the substrates in the clearance 21. The spherical absorbent can prevent the luminescent material 19 from being affected by humidity, which is effective in suppressing the deterioration of the light emitting properties of the luminescent material 19.

The present invention is described to be applied to the light emitting devices 10, 30 and 40 each of which includes one pixel. Alternatively, a plurality of electrodes may be provided in areas defined by the sealant, so that the electrodes function as pixels and emit light as visual signals. In such a case, images can be displayed on an area where electrodes are placed.

The luminescent material 19 is utilized in the first and second embodiments. Alternatively, liquid crystals, electrophoretic materials, electrochemical (EC) materials, electro-wetting materials and so on which are not luminescent in themselves but display images in response to external light. For instance, one example of electrophoretic materials is a so-called charged carbon black made of minute black powders dissolved in a solvent (isoparaffin and so on). An EC material may be a tungsten-group material (W0₃) which emits light in response to voltage application, and is applied onto the electrodes. In this case, a propylene carbonate (PC) solution prepared by dissolving LiClO₄ is filled in a cell. The electro-wetting is one of display processes. Water and colored oil droplets (cyan, magenta and yellow) corresponding to the pixels are sealed in the cell. When a voltage is applied to the electrode via a rear electrode which is hydrophobic and insulated, the surface tension of the oil droplets is changed so that the oil droplets are deformed and produce color images. Therefore, when the voltage is applied between the first electrode 15 (35, 45) and the second electrode 16 (36, 46), transmission factors or a reflectance of light in the display material can be changed. For instance, when the display material is electrophoretic, black minute powders are dispersed in a solvent. In response to the voltage application between electrodes, the black minute powders are eccentrically moved, which promotes transmission of light, and improves transmittance of light. Further, with an electrophoretic micro-capsule type material, a positively charged white pigment and a negatively charged black pigment are dispersed in a transparent insulating solvent. By applying a voltage between electrodes, the white pigment is moved toward a surface of a material layer while the black pigment is moved toward the other surface of the material layer, or the white black pigment is moved toward one surface of the material layer while the black pigment is moved toward the other surface. Therefore, reflectance of light arriving from one surface can be changed. With a liquid crystal, the orientation of the liquid crystal is changed in response to a voltage applied between electrodes, which is effective in changing the transmittance of light.

In the first embodiment of the invention, the distance between the substrates 11 and 12 in the clearance 21 is larger than the distance between the substrates 11 and 12 in the clearance 17, which is effective in preventing the luminescent material 19 in the clearance 17 from being in contact with the sealant 13. In addition, the surfaces of the substrates 11 and 12 in the clearance 21 may have the affinity with the luminescent material 19 which is smaller than the affinity of the substrate surfaces, where the electrodes 15 and 16 are placed, with the luminescent material 19. In this case, the luminescent material 19 is prevented from moving to the clearance 21, which enables the luminescent material 19 to be kept apart from the sealant 13 in addition to the effect resulting from capillary phenomenon.

In the second embodiment of the invention, the surfaces of the substrates 11 and 12 in the clearance 21 may have the affinity with the luminescent material 19 which is smaller than the affinity of the substrate surfaces, where the electrodes 15 and 16 are placed, with the luminescent material 19. In addition, the distance between the substrates 11 and 12 in the clearance 21 may be larger than the distance between the substrates 11 and 12 in the clearance 17. This measure is effective in preventing the luminescent material 19 from moving to the clearance 21 because of the effect of the capillary phenomenon, and keeping the luminescent material 19 from being in contact with the sealant 13.

What is claimed is:

1. A light emitting device comprising:
a first substrate;
a second substrate facing with the first substrate;
a liquid or gelled luminescent material filled in a clearance between the first substrate and the second substrate;
a first electrode placed on the first substrate and being in contact with the luminescent material;
a second electrode placed on the second substrate and being in contact with the luminescent material; and
a sealant placed between the first substrate and the second substrate, being separate from the luminescent material, and isolating the luminescent material from an environment;
wherein a first distance between the first substrate and the second substrate in an area where the luminescent material and the sealant are separate from each other is larger than a second distance between the first substrate and the second substrate in the clearance where the luminescent material is filled; and a third distance in the area between the luminescent material and the sealant is larger than the second distance.

2. The device of claim 1, wherein the luminescent material is an ECL material which has electrochemical luminescent properties (ECL) and emits light in response to voltage application between the first and second electrodes.

3. The device of claim 1, wherein an absorbent is placed in the area where the luminescent material and the sealant are separate from each other.

4. The device of claim 1, wherein the distance m×d between the first substrate and the second substrate in the clearance where the luminescent material and the sealant are separate from each other, when the character d denotes the distance between the first and second substrates in the clearance where the luminescent material is placed; and the character m is designed to satisfy the following formula:
d×t×h×ρ×(1+1/m)×(h/2)+γ_{GL}·{dt(1−m)}+(γ_{LS}−γ_{SG})·{(1−1/m) 2ht−(m−1) dt}<0
which is derived using the following parameters: the character h denoting a length of a first side of the rectangular clearance where the luminescent material is placed and which extends along the first or second substrate; the character t denoting a length of a second side connecting to the first side of the clearance where the luminescent material is placed; the character ρ denoting the density of the luminescent material; the character γ_{GL} denoting a surface tension acting on the luminescent material and a gas filled in the light emitting device when the luminescent material moves from the area where the luminescent material and the sealant are separate from each other to the clearance where the luminescent material is placed; the character γ_{LS} denoting a surface tension acting on the luminescent material and the first and second substrates; the character γ_{SG} denoting a surface tension acting on the first and second substrates and the gas filled in the light emitting device; the character ΔS_{LS} denoting a variation of an area S_{LS} of an interface of the luminescent material and the first and second substrates; and the character ΔS_{GL} denoting a variation of the area of the interface of the luminescent material and the gas.

5. A display device comprising:
a first substrate;
a second substrate facing with the first substrate;
a liquid or gelled display material filled in a clearance between the first substrate and the second substrate;
a first electrode placed on the first substrate and being in contact with the display material;
a second electrode placed on the second substrate and being in contact with the display material; and
a sealant placed between the first substrate and the second substrate, being separate from the display material, and isolating the display material from an environment;
wherein a first distance between the first substrate and the second substrate in an area where the display material and the sealant are separate from each other is larger than a second distance between the first substrate and the second substrate in the clearance where the display material is filled; and a third distance in the area between the display material and the sealant is larger than the second distance.

6. The device of claim 5, wherein the display material changes light transmission in response to voltage application between the first electrode and the second electrode.

7. The device of claim 5, wherein the display material changes light reflectance in response to voltage application between the first electrode and the second electrode.

8. The device of claim 5, wherein the distance m×d between the first substrate and the second substrate in the clearance where the display material and sealant are separate from each other, when the character d denotes the distance between the first and second substrates in the clearance where the display material is placed; and the character m is designed to satisfy the following formula:
d×t×h×ρ×(1+1/m)×(h/2)+γ_{GL}·{dt(1−m)}+(γ_{LS}−γ_{SG})·{(1−1/m) 2ht−(m−1)dt}<0
which is derived using the following parameters: the character h denoting a length of a first side of the rectangular clearance where the display material is placed and which extends along the first or second substrate; the character t denoting a length of a second side connecting to the first side of the clearance where the display material is placed; the character ρ denoting the density of the display material; the character γ_{GL} denoting a surface tension acting on the display material and a gas filled in the display device when the display material moves from the area where the display material and the sealant are separate from each other to the clearance where the display material is placed; the character γ_{LS} denoting a surface tension acting on the display material and the first and second substrates; the character γ_{SG} denoting a surface tension acting on the first and second substrates and the gas filled in the display device; the character ΔS_{LS} denoting a variation of an area S_{LS} of an interface of the display material and the first and second substrates; and the character ΔS_{GL} denoting a variation of the area of the interface of the display material and the gas.

9. A light emitting device comprising:
a first substrate;
a second substrate facing with the first substrate;
a liquid or gelled luminescent material filled in a clearance between the first substrate and the second substrate;
a first electrode placed on the first substrate and being in contact with the luminescent material;
a second electrode placed on the second substrate and being in contact with the luminescent material; and
a sealant placed between the first substrate and the second substrate, being separate from the luminescent material, and isolating the luminescent material from an environment;
wherein an affinity between the luminescent material and the first and second substrates in a first area where the luminescent material and the sealant are separate from each other is lower than an affinity between the first substrate and the second substrate in a second area where the luminescent material is filled.

10. The device of claim 9, wherein surfaces of the first and second substrates in the first area are hydrophilic while surface of the first and second substrates in the second area are hydrophobic.

11. The device of claim 9, wherein surfaces of the first and second substrates in the first area are hydrophobic while surfaces of the first and second substrates in the second area are hydrophilic.

12. The device of claim 9, wherein the luminescent material is an ECL material which has electrochemical luminescent properties (ECL) and emits light in response to voltage application between the first and second electrodes.

13. A display device comprising:
a first substrate;
a second substrate facing with the first substrate;
a liquid or gelled display material filled in a clearance between the first substrate and the second substrate;
a first electrode placed on the first substrate and being in contact with the display material;
a second electrode placed on the second substrate and being in contact with the display material; and
a sealant placed between the first substrate and the second substrate, being separate from the display material, and isolating the display material from an environment;
wherein an affinity between the display material and the first and second substrates in a first area where the display material and the sealant are separately placed is lower than an affinity between the first substrate and the second substrate in a second area where the display material is provided.

14. The device of claim 13, wherein surfaces of the first and second substrates in the first area are hydrophilic while surface of the first and second substrates in the second area are hydrophobic.

15. The device of claim 13, wherein surfaces of the first and second substrates in the first area are hydrophobic while surfaces of the first and second substrates in the second area are hydrophilic.

16. The device of claim 13, wherein the display material changes transmittance thereof in response to voltage application between the first and second electrodes.

17. The device of claim 13, wherein the display material changes reflectance thereof in response to voltage application between the first and second electrodes.

18. A method of fabricating a light emitting device, the method comprising:
polishing a periphery of an electrode forming region where an electrode of a first substrate is formed, and raising the electrode forming region;
polishing a periphery of an electrode forming region where an electrode of a second substrate is formed, and raising the electrode forming region;
spraying a spacer onto the first electrode forming region or the second electrode forming region;
placing the first and second substrates in such a manner that the first electrode forming region and the second electrode forming region face with each other via the spacer;
partly sealing a peripheral area of a clearance between the first and second substrates;
filling a luminescent material into the clearance between the first and second electrode forming regions via a non-sealed peripheral area; and
closing the non-sealed peripheral area of the clearance between the first and second substrates.

19. The method of claim 18, wherein the luminescent material is an ECL material which has electrochemical luminescent properties (ECL) and emits light in response to voltage application between the first and second electrodes.

20. A method of fabricating a display device, the method comprising:
polishing a periphery of an electrode forming region where an electrode of a first substrate is formed, and raising the electrode forming region;
polishing a periphery of an electrode forming region where an electrode of a second substrate is formed, and raising the electrode forming region;
spraying a spacer onto the first electrode forming region or the second electrode forming region;
placing the first and second substrates in such a manner that the first electrode forming region and the second electrode forming region face with each other via the spacer;
partly sealing a peripheral area of a clearance between the first and second substrates;
filling a display material into the clearance between the first and second electrode forming regions via a non-sealed peripheral area; and
closing the non-sealed peripheral area between the first and second substrates.

21. The method of claim 20, wherein the display material changes light transmittance thereof in response to voltage application between the first and second electrodes.

22. The method of claim 20, wherein the display material changes light reflectance thereof in response to voltage application between the first and second electrodes.
